(19) United States
(12) Patent Application Publication
(10) Pub. No.: US 2024/0085899 A1
(43) Pub. Date: Mar. 14, 2024

(54) DATA ANALYSIS APPARATUS, DATA ANALYSIS METHOD, AND STORAGE MEDIUM

(71) Applicant: KABUSHIKI KAISHA TOSHIBA, Tokyo (JP)

(72) Inventors: Jumpei ANDO, Yokohama Kanagawa (JP); Wataru WATANABE, Tokyo (JP); Takayuki ITOH, Kawasaki kanagawa (JP); Keisuke KAWAUCHI, Kawasaki kanagawa (JP); Toshiyuki ONO, Kawasaki kanagawa (JP)

(73) Assignee: KABUSHIKI KAISHA TOSHIBA, Tokyo (JP)

(21) Appl. No.: 18/176,292

(22) Filed: Feb. 28, 2023

(30) Foreign Application Priority Data
Sep. 14, 2022 (JP) 2022-146366

(51) Int. Cl. G05B 23/02

(52) U.S. Cl. CPC G05B 23/0281; G05B 23/0262

(57) ABSTRACT

According to one embodiment, a data analysis apparatus includes processing circuitry. The processing circuitry acquires first factor data indicative of first manufacturing conditions of a first product, and acquires second factor data indicative of second manufacturing conditions of a second product. The processing circuitry computes, based on the first factor data, a first index value relating to a degree by which each of the first manufacturing conditions contributes to an abnormality, and computes, based on the second factor data, a second index value relating to a degree by which each of the second manufacturing conditions contributes to an abnormality. The processing circuitry computes a similarity between the first index value and the second index value.

### CROSS-REFERENCE TO RELATED APPLICATION

This application is based upon and claims the benefit of priority from prior Japanese Patent Application No. 2022-146366, filed Sep. 14, 2022, the entire contents of which are incorporated herein by reference.

### FIELD

Embodiments described herein relate generally to a data analysis apparatus, a data analysis method, and a storage medium.

### BACKGROUND

In the manufacture of products, an improvement in productivity is required. For the improvement in productivity, it is important to maintain and improve the yield of products. In many manufacturing industries, data in manufacturing processes are collected, monitored and analyzed to find an abnormality, and the cause of the abnormality is specified. Thereafter, a measure against the abnormality cause is implemented, and the yield is maintained and improved. However, it is necessary to shorten a period from the occurrence of the abnormality until the implementation of the measure. The reason for this is that if the period until the implementation of the measure is short, the manufacture of defective products can be reduced, and a high yield can be achieved.

On the other hand, there are known a method of automatically detecting an abnormality and a method of estimating an abnormality cause. For example, in the method of automatically detecting an abnormality, an abnormal product having an outlier or a value deviating from a standard value is automatically detected in regard to individual data of products, such as dimensions of products or characteristic values. In the method of estimating an abnormality cause, an abnormal case having similar individual data, among the individual data of past abnormal products, is searched based on the individual data of a detected abnormal product, and a discovered past abnormal case is presented.

According to the study by the present inventor, in this method of estimating the abnormality cause, for example, in a case where a plurality of past abnormal cases having similar individual data are discovered, even if the individual data are similar in the abnormal cases, abnormality causes in the manufacturing process are not always similar. Thus, according to the study by the present inventor, the method of estimating the abnormality cause is in such a condition that the accuracy in the case of estimating the abnormality cause in the manufacturing process is low.

### BRIEF DESCRIPTION OF THE DRAWINGS

FIG. 1 is a block diagram illustrating an example of a data analysis apparatus according to a first embodiment.

FIG. 2 is a view illustrating an example of factor data according to the first embodiment.

FIG. 3 is a view illustrating an example of state data according to the first embodiment.

FIG. 4 is a flowchart for describing an operation in the first embodiment.

FIG. 5 is a schematic view for describing an operation in the first embodiment.

FIG. 6 is a view illustrating an example of first factor data D according to the first embodiment.

FIG. 7 is a view illustrating an example of second factor data D1 according to the first embodiment.

FIG. 8 is a view illustrating an example of second factor data D2 according to the first embodiment.

FIG. 9 is a view illustrating an example of a totalization table relating to the first factor data D according to the first embodiment.

FIG. 10 is a view illustrating an example of a table of bias rates based on the totalization table according to the first embodiment.

FIG. 11 is a schematic view for describing an operation in the first embodiment.

FIG. 12 is a block diagram of a data analysis apparatus according to a modification of the first embodiment.

FIG. 13 is a block diagram illustrating an example of a data analysis apparatus according to a second embodiment.

FIG. 14 is a flowchart for describing an operation in the second embodiment.

FIG. 15 is a block diagram illustrating a data analysis apparatus according to a third embodiment.

FIG. 16 is a view illustrating an example of a defect database according to the third embodiment.

FIG. 17 is a flowchart for describing an operation in the third embodiment.

FIG. 18 is a view illustrating an example of a display mode of a display device according to the third embodiment.

FIG. 19 is a block diagram of a data analysis apparatus according to a modification of the third embodiment.

FIG. 20 is a view illustrating an example of a hardware configuration of a data analysis apparatus according to a fourth embodiment.

### DETAILED DESCRIPTION

In general, according to one embodiment, a data analysis apparatus includes processing circuitry. The processing circuitry is configured to designate a first condition indicative of a first product of an analysis target. The processing circuitry is configured to designate a second condition indicative of a second product of a comparison target. The processing circuitry is configured to acquire, based on the first condition, first factor data indicative of a plurality of first manufacturing conditions of the first product, and acquire, based on the second condition, second factor data indicative of a plurality of second manufacturing conditions of the second product. The processing circuitry is configured to compute, based on the first factor data, a first index value relating to a degree by which each of the first manufacturing conditions contributes to an abnormality cause of the first product, and compute, based on the second factor data, a second index value relating to a degree by which each of the second manufacturing conditions contributes to an abnormality cause of the second product. The processing circuitry is configured to compute a similarity between the first index value and the second index value.

Hereinafter, embodiments are described with reference to the accompanying drawings. In the description below, by way of example, a case is described in which a data analysis apparatus analyzes a product and data of a manufacturing condition of the product. Note that the term “data analysis apparatus” may be replaced with a freely chosen term such as “similarity computation apparatus” in accordance with concrete processes.

### First Embodiment

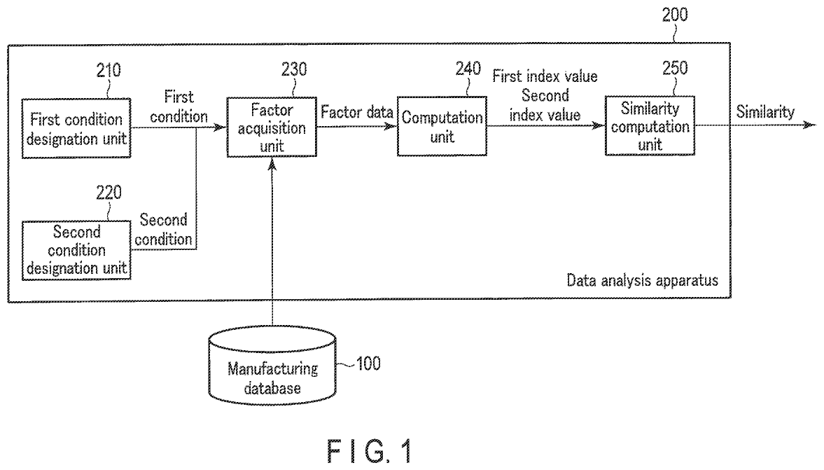

FIG. 1 is a block diagram illustrating a data analysis apparatus according to a first embodiment. A data analysis apparatus 200 includes a first condition designation unit 210, a second condition designation unit 220, a factor acquisition unit 230, a computation unit 240, and a similarity computation unit 250. The data analysis apparatus 200 is connected to a manufacturing database 100 in which the data relating to product manufacturing is stored. The manufacturing database 100 and a defect database (not illustrated) may be provided, for example, separately from the data analysis apparatus 200, or may be provided in the data analysis apparatus 200.

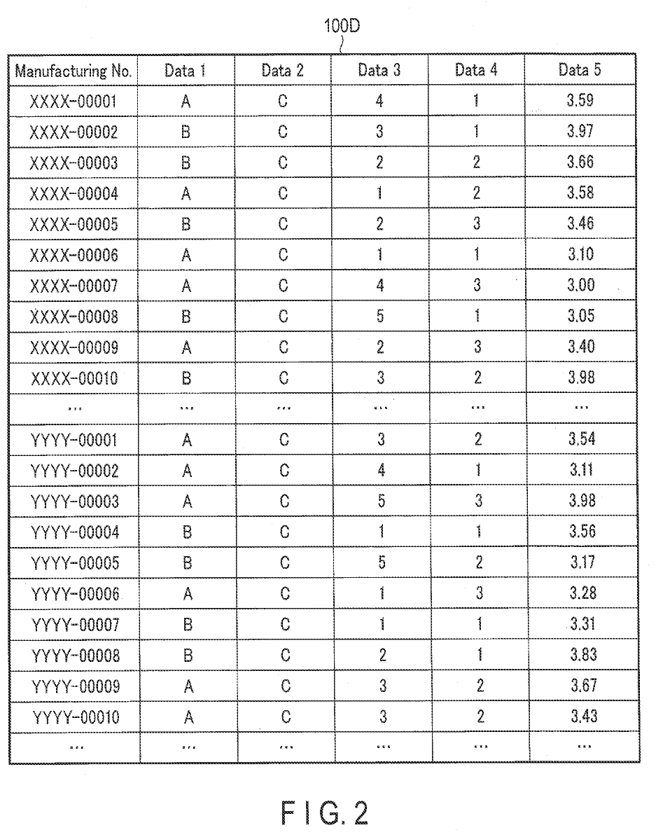

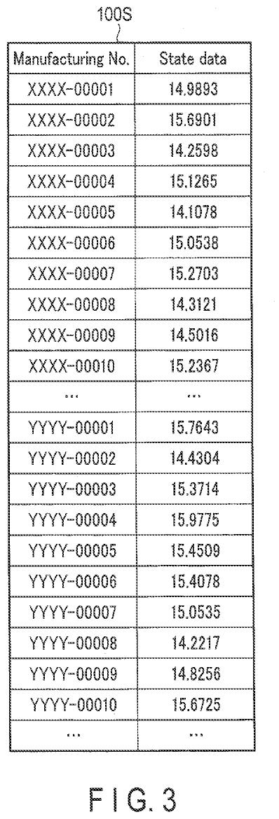

As illustrated in FIG. 2 and FIG. 3, the manufacturing database 100 stores manufacturing data including factor data 100D and state data 100S. Note that the factor data 100D is information relating to manufacturing conditions, such as apparatuses and materials used in product manufacturing, and settings of the apparatuses. The state data 100S is data relating to states of products, such as dimensions and electrical characteristics of products. Each of the factor data 100D and state data 100S includes a manufacturing number for identifying which product the data relates to, and the manufacturing number can be correlated with each data as a connection key. For example, in the factor data 100D, the manufacturing number of a product and data 1 to 5 indicative of the manufacturing conditions of the product are correlated and stored. In the state data 100S, the manufacturing number of a product and state data indicative of the state of the product are correlated and stored.

Here, more generally, the factor data 100D uses information relating to 5M1E as manufacturing conditions. 5M1E is a term based on the initials of Man, Machine, Material, Method, Measurement, and Environment, and is widely known as six factors for managing manufacturing processes. The information of “Man” includes information such as the name of a processing person. The information of “Machine” includes information such as the name of an apparatus used for product manufacturing, the name of a manufacturing line, and the states of the apparatus at a time of processing such as a temperature and a pressure. The information of “Material” includes information such as the ID or name of a material used in product manufacturing, and the ID or name of parts constituting a product. The information of “Method” includes information such as a product processing method and the kind of processing program. The information of “Measurement” includes information such as the name of an apparatus that was measured, and measurement locations of a product that was measured. The information of “Environment” includes information such as the name of a factory building in which measurement was conducted, and a temperature and humidity at a time of measurement. In addition, for example, the manufacturing conditions may further include the following information (Da) to (Dd). However, the information that may be included as manufacturing conditions is not limited to (Da) to (Dd).

(Da) A manufacturing lot indicative of a manufacturing unit, the date (manufacturing date) of the manufacture of a product, and times of passage through the apparatus and processes used in the manufacture.

(Db) The apparatus and material used in the product manufacturing, and the name of a person in charge of the product manufacture.

(Dc) Settings of the manufacturing apparatus, such as voltage and an apparatus mode.

(Dd) Data relating to output values of a manufacturing apparatus and an inspection apparatus, and the states of a product such as dimensions and electrical characteristics.

More generally, the state data 100S uses, as state data, the information relating to quality control (QC) of products. In addition, as the state data, use may be made of data correlated with an individual product, which is considered to be useful for analysis. For example, the state data may include the following data (Sa) and (Sb). However, the data that may be included as the state information are not limited to the following (Sa) and (Sb).

(Sa) Data used for the quality control of products (the dimensions of products, and electrical characteristics such as voltage and resistance).

(Sb) Flag information that is an inspection result of products.

Note that the manufacturing database 100 may be constituted by a general relational database management system (RDBMS). The manufacturing database 100 may be, for example, an NoSQL (Not only SQL) database. In addition, the manufacturing data stored in the manufacturing database 100 may be composed of a file of a predetermined format such as CSV (Comma Separated Value).

The first condition designation unit 210 designates a first condition indicative of a product (first product) of an analysis target. Specifically, for example, the first condition designation unit 210 designates a first condition indicative of a product group of an analysis target of the manufacturing database 100. For example, a list of a plurality of manufacturing numbers is prepared, and products included in the list can be designated. For example, this corresponds to a case where, in the case of the factor data 100D illustrated in FIG. 2, manufacturing numbers XXXX-00001 to XXXX-00010 are set as the first condition. In addition, products of an analysis target may be designated by using, aside from the manufacturing numbers, products in regard to which the factor data 100D meets a predetermined condition. For example, this corresponds to a case where a condition is designated for the factor data 100D such as the manufacturing lot or the manufacturing date.

The second condition designation unit 220 designates a second condition indicative of a product (second product) of a comparison target. As regards the method of designation, like the first condition designation unit 210, the designation may be executed by using manufacturing numbers, or the designation may be executed by using, aside from the manufacturing numbers, products in regard to which the factor data 100D meets a predetermined condition. The second condition designates products different from the first condition. Note that the products designated by the second condition may partly overlap the products designated by the first condition. For such a case as searching similar cases from among a plurality of cases, a plurality of second conditions may be designated. In this case, similarities, the number of which corresponds to the number of second conditions, are computed.

The factor acquisition unit 230 acquires, based on the first condition, first factor data indicative of a plurality of first manufacturing conditions of the product (first product) of the analysis target, and acquires, based on the second condition, second factor data indicative of a plurality of second manufacturing conditions of the product (second product) of the comparison target. For example, the factor acquisition unit 230 acquires the factor data in regard to the products designated by the first condition and the second condition, among the factor data 100D in the manufacturing database 100.

The computation unit 240 computes, based on the first factor data, a first index value relating to a degree by which each of the first manufacturing conditions contributes to an abnormality cause of the product (first product) of the analysis target. In addition, the computation unit 240 computes, based on the second factor data, a second index value relating to a degree by which each of the second manufacturing conditions contributes to an abnormality cause of the product (second product) of the comparison target. Here, the degree of the contribution to the abnormality cause of the product is a value representing how much the factor data indicative of the manufacturing condition of the product influences the occurrence of an abnormality of the product.

The similarity computation unit 250 computes a similarity between the first index value and the second index value. As regards the computation method of similarity, for example, a Pearson's product-moment correlation coefficient may be used as a distance index, or other mathematical distance indices, such as an L1 norm, an L2 norm and cosine similarity, may be used. In addition, for example, as the computation method of similarity, use may be made of an index, such as Kullback-Leibler information, which does not meet an axiom of distance but quantifies a difference between two data. Besides, for example, as the computation method of similarity, non-similarity (a degree of not being similar) may be used.

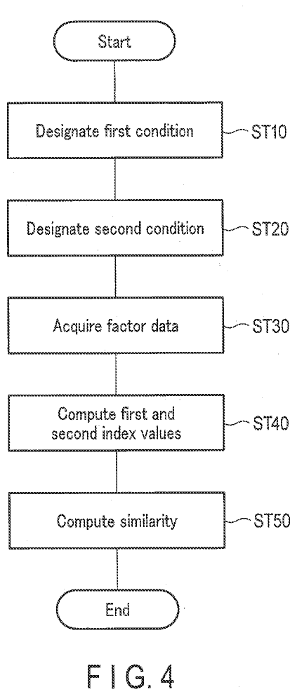

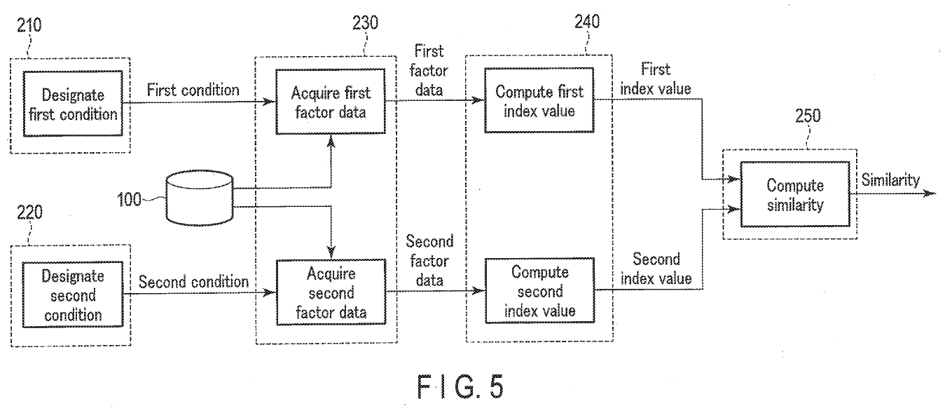

Next, an operation of the data analysis apparatus with the above configuration is described with reference to a flowchart of FIG. 4 and schematic views of FIG. 5 to FIG. 11.

(Step ST10)

As illustrated in FIG. 4 and FIG. 5, the first condition designation unit 210 designates a first condition indicative of a product (hereinafter, also referred to as “first product”) of an analysis target. For example, the first condition designation unit 210 designates, as the first condition, manufacturing numbers XXXX-00001 to XXXX-00010 indicative of the products of the analysis target, among the factor data 100D illustrated in FIG. 2.

(Step ST20)

The second condition designation unit 220 designates a second condition indicative of a product (hereinafter, also referred to as “second product”) of a comparison target. For example, the second condition designation unit 220 designates, as a second condition of first designation, manufacturing numbers YYYY-00001 to YYYY-00010 indicative of the products of the comparison target, among the factor data 100D illustrated in FIG. 2. Similarly, for example, the second condition designation unit 220 designates, as a second condition of a second time, manufacturing numbers ZZZZ-00001 to ZZZZ-00010 indicative of the second products, among the factor data 100D. However, the second condition of the second time or the following may not be designated.

(Step ST30)

The factor acquisition unit 230 acquires, based on the first condition, first factor data indicative of a plurality of first manufacturing conditions of the first product. In addition, the factor acquisition unit 230 acquires, based on the two second conditions, second factor data indicative of a plurality of second manufacturing conditions of the second product. Each acquired factor data is composed of table data in which the number of rows is the number of conditions, and the number of columns is the number of items of factors. Note that in the case of the first condition, the number of conditions is the number of manufacturing numbers designated by the first condition. Similarly, in the case of the second condition, the number of conditions is the number of manufacturing numbers designated by the second condition. Note that the number of manufacturing numbers is also the number of products.

In addition, for example, if the number of products designated by the first condition is 10 and the number of items of factors is 5, the factor data is table data of 10 rows×5 columns. The same applies to the second condition. In addition, if a plurality of second conditions are designated, table data, the number of which is the number of conditions, are obtained. For example, if two second conditions are designated, it is assumed that the two second conditions are a second condition 1 (the number of products is 15) and a second condition 2 (the number of products is 10). In this case, the factor data corresponding to the second condition 1 are factor data of 15 rows, and the factor data corresponding to the second condition 2 are factor data of 10 rows.

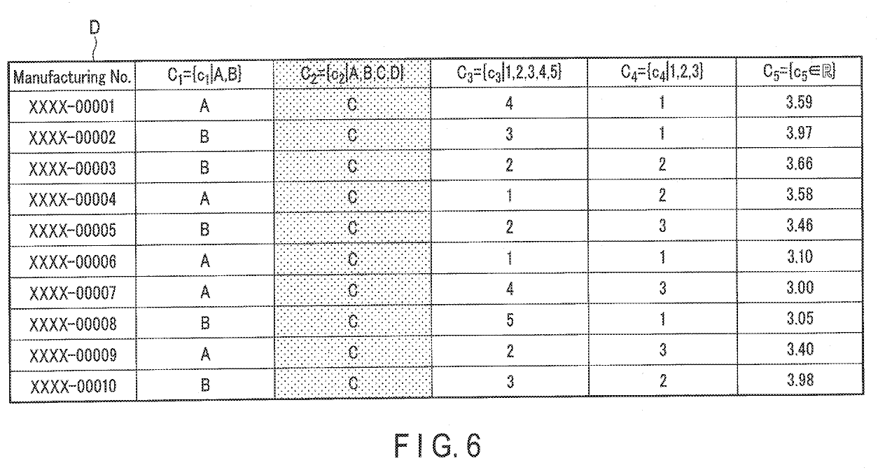

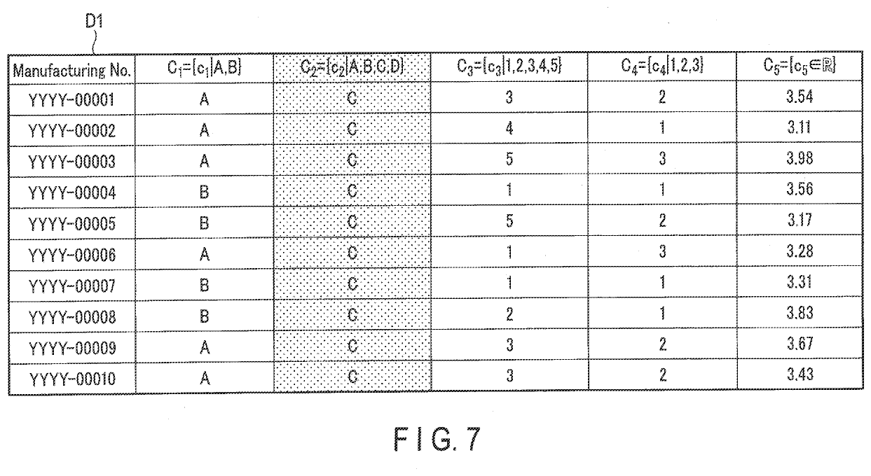

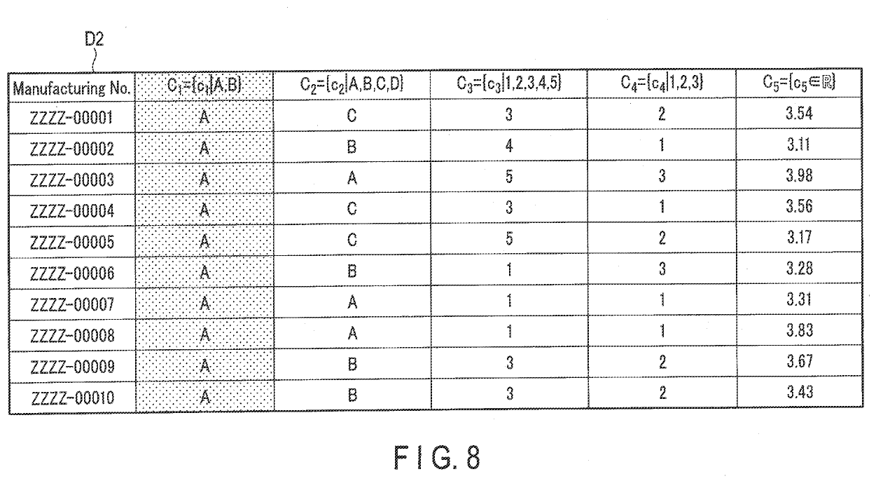

In the description below, by way of example, such a problem is described that, in regard to the first product group (first condition) in which an abnormality occurred, a second product group, in which an abnormality similar to the abnormality of the first condition occurred, is searched from among an I-number of second product groups (second condition i (i=1, . . . , I)) in which an abnormality occurred in the past. “I” indicates the number of second conditions, and it is assumed here that the number of second conditions is two (I=2). FIG. 6 illustrates first factor data D acquired from the manufacturing database 100 by the first condition. FIG. 7 illustrates second factor data D1 acquired by the second condition 1, and FIG. 8 illustrates second factor data D2 acquired by the second condition 2. The first factor data D acquired by the first condition is table data in which columns are manufacturing conditions Cj (j=1, . . . , J=5), and rows are second products. The same applies to second factor data Di acquired by the second condition. Based on the above settings, the following description is given.

(Step ST40)

The computation unit 240 computes, in regard to the first factor data D, a first index value F(D) relating to a degree of contribution to the occurrence of the first product designated by the first condition. In addition, the computation unit 240 computes, in regard to the second factor data Di, a second index value F(Di) relating to a degree of contribution to the occurrence of the second product designated by the second condition. Note that the degree of contribution to the abnormality cause of the first product is a value representing how much the manufacturing condition that is each column in the first factor data D contributes to the abnormality cause of the first product. Similarly, the degree of contribution to the abnormality cause of the second product is a value representing how much the manufacturing condition that is each column in the second factor data Di contributes to the abnormality cause of the second product.

Here, a bias relating to a specific manufacturing condition is quantified as the index value, but the index value is not limited to this. In the case of quantifying the bias, for example, there is a method in which a totalization table relating to items of manufacturing conditions is created in regard to each manufacturing condition Cj (each column of factors) of the factor data D of the first condition, and each element of the totalization table is divided by the total number of products, and thereby a bias rate (frequency distribution Od {d=1, 2, . . . , K}) for each element of the manufacturing condition is computed. Thereafter, a maximum value of bias rates for the respective elements of the manufacturing condition Cj is set as a bias rate rj of the manufacturing condition Cj, and a vector including rj as an element is quantified as a first index value F(D)=(r1, . . . , rJ). By the same method, a second index value F(Di) can be computed.

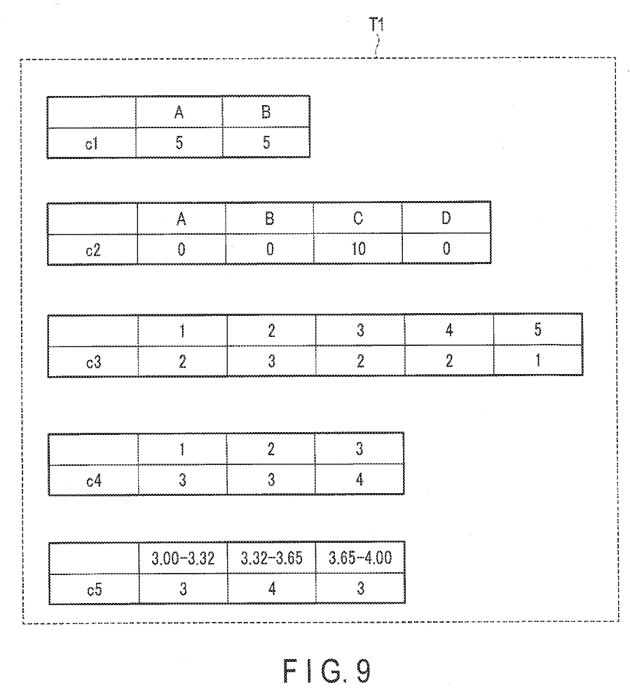

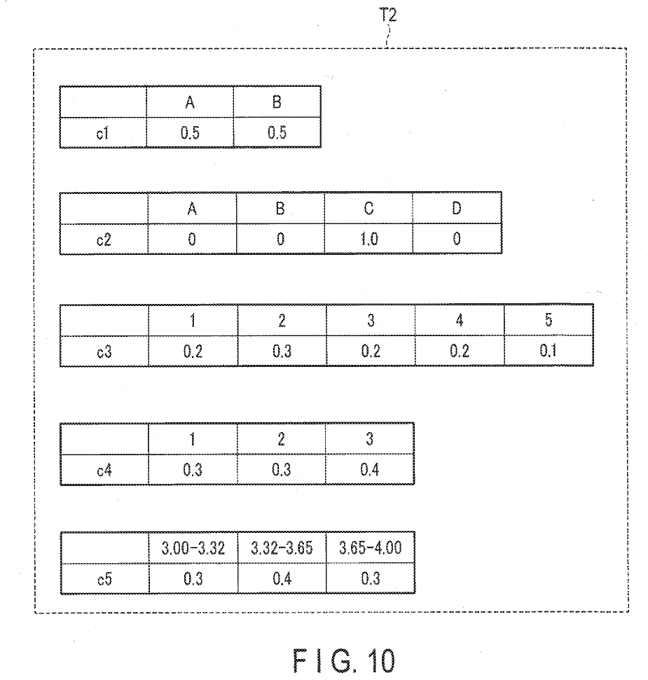

In connection with the manufacturing condition Cj of the first factor data D of FIG. 6, FIG. 9 illustrates a totalization table T1, and FIG. 10 illustrates a table T2 of bias rates computed by dividing each element of the totalization table T1 by the total number of products. The bias rate of the manufacturing condition C1 is 0.5, the bias rate of the manufacturing condition C2 is 1.0, the bias rate of the manufacturing condition C3 is 0.3, the bias rate of the manufacturing condition C4 is 0.4, and the bias rate of the manufacturing condition C5 is 0.4, and the first index value F(D)=(0.5, 1.0, 0.3, 0.4, 0.4) is computed. For example, the bias rate “1.0” of the manufacturing condition C2 reflects a high bias to the item C. By the same method, in regard to the second condition, the bias relating to the manufacturing condition can be quantified.

(Step ST50)

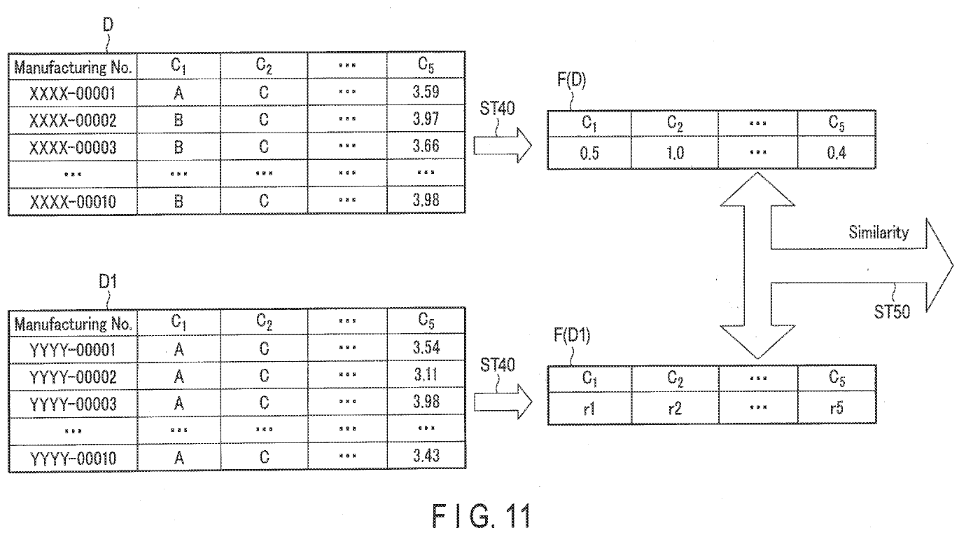

The similarity computation unit 250 computes a similarity Si between the first index value F(D) and the second index value F(Di). In this example, as illustrated in FIG. 11, in a case of i=1 of the second condition i, the similarity computation unit 250 computes a similarity S1 between the first index value F(D) and the second index value F(D1). Similarly, the similarity computation unit 250 computes a similarity S2 between the first index value F(D) and the second index value F(D2). Note that as the similarity Si, for example, use may be made of a mathematical distance index, or an index that is not a distance index but quantifies a difference between two data.

Thereafter, of the two computed similarities S1 and S2, a higher similarity Si is selected, and thereby a second condition i with a similar bias of the manufacturing condition Cj can be searched. In addition, from the second index value F(Di) and the second factor data Di corresponding to the higher similarity Si, an abnormality cause can be estimated as an item of the manufacturing condition Cj having a high bias.

As described above, according to the first embodiment, the first condition designation unit 210 designates the first condition indicative of the first product of the analysis target. The second condition designation unit 220 designates the second condition indicative of the second product of the comparison target. The factor acquisition unit 230 acquires, based on the first condition, first factor data indicative of a plurality of first manufacturing conditions of the first product, and acquires, based on the second condition, second factor data indicative of a plurality of second manufacturing conditions of the second product. The computation unit 240 computes, based on the first factor data, a first index value relating to a degree by which each of the first manufacturing conditions contributes to an abnormality cause of the first product. In addition, the computation unit 240 computes, based on the second factor data, a second index value relating to a degree by which each of the second manufacturing conditions contributes to an abnormality cause of the second product. The similarity computation unit 250 computes a similarity between the first index value and the second index value.

In this manner, according to the first embodiment, by the configuration that computes the index values based on the manufacturing conditions of the products and computes the similarity of the index values, since the similarity of manufacturing conditions is taken into account, the accuracy in the case of estimating the abnormality cause in the manufacturing process can be improved.

If a supplementary description is given, as a first comparative example, a method is assumed in which, based on individual data of detected abnormal products, an abnormal case with similar individual data, among the individual data of abnormal products in the past, is searched, and a discovered abnormal case in the past is presented. In the first comparative example, individual data that are objects are values that are output from a manufacturing apparatus or an inspection apparatus, such as dimensions or characteristic values of products. Accordingly, in the first comparative example, since no consideration is given to which apparatus was used to manufacture a product, which material was used to manufacture a product, and no consideration is given to the similarity of manufacturing conditions such as settings of the apparatus, the comparative example is in such a condition that the accuracy in the case of estimating the abnormality cause in the manufacturing process is low.

In addition, as a second comparative example, there is a method in which, based on the bias of abnormality for each manufacturing condition in regard to various data acquired in the manufacturing process, an index value indicative of the likelihood of a cause is computed, and a manufacturing condition that is an abnormality cause is estimated, thereby supporting the determination of the cause. However, in the second comparative example, since past cases are not considered, a similar past case cannot be searched. Thus, in the second comparative example, in a case where a plurality of index values are high and are computed as likely causes, there is a possibility that time is needed to specify a true abnormality cause.

By contrast, according to the first embodiment, for example, if a plurality of cases with similar individual data are discovered, a past case and another past case, in which an abnormality occurred under the same manufacturing condition, can be separated by taking the similarity of manufacturing conditions into account. In addition, by searching an abnormality with similar manufacturing conditions such as apparatuses and materials, an abnormality cause can be estimated with higher accuracy, and a work time for specifying an abnormality cause by an engineer at the site of manufacture can be shortened. Accordingly, it can be expected that the period until implementing measures is shortened. Therefore, according to the first embodiment, in the case of presenting similar past cases, based on manufacturing conditions, the efficiency of determining causes can be enhanced by searching and presenting past cases by narrowing down the past cases to cases with similar causes.

### Modifications of the First Embodiment

Next, modifications of the first embodiment are described. Each modification is similarly applicable to embodiments to be described below.

In the first embodiment, two second conditions i (i=1, 2) are used, but the first embodiment is not limited to this. For example, the second condition designation unit 220 may designate one second condition i, which is different from the first condition, or may designate three or more conditions i, which are different from the first condition. No matter which of one or more second conditions i, which are different from the first condition, is designated, the factor acquisition unit 230 acquires the second factor data Di in regard to each second condition i. The computation unit 240 computes the second index value F(Di) in regard to each second factor data Di. The similarity computation unit 250 computes the similarity Si in regard to each second index value F(Di). Thus, according to this modification, the same operation and advantageous effect as in the first embodiment can be obtained. In addition, according to this modification, for example, if it is to be confirmed that the abnormality cause of the first product at this time is the same as a typical abnormality cause of the second product in the past, the abnormality cause can be confirmed by designating one second condition i.

In addition, in the first embodiment, the bias rate in regard to each manufacturing condition is used as the index value, but the first embodiment is not limited to this. For example, the computation unit 240 may use a method of quantifying, as an index value, a bias relating to a specific manufacturing condition in a framework of a statistical test. In this case, the computation unit 240 computes the first index value, based on the first factor data and a statistical hypothesis test, and computes the second index value, based on the second factor data and a statistical hypothesis test. Hereinafter, although a modification is described in which the framework of a likelihood ratio test called a G-test is used as the statistical test for a variable of a nominal scale like a manufacturing apparatus, the modification is not limited to this. For example, a chi-square test may be used as the statistical hypothesis test. Aside from this, the computation unit 240 may use other test methods.

Here, the computation unit 240 computes a p-value that is a probability value obtained by testing a signification of a bias in regard to each manufacturing condition Cj (j=1, . . . , J) that is each column of the first factor data D, and sets a vector, which includes the p-value for each manufacturing condition Cj as an element, as the first index value F(D)=(p1, . . . , pJ). In the case of computing the p-value for each manufacturing condition, a totalization table relating to items of manufacturing conditions is created in regard to each manufacturing condition Cj (each column) of the factor data D of the first condition, and each element of the totalization table is divided by the total number of products, and thereby a frequency distribution Od {d=1, 2, . . . , K} for each item d of the manufacturing condition is computed. The number of kinds of items of the manufacturing condition is set to be K. At this time, the manufacturing data of the first products of the analysis target is regarded as a population set, and such a null hypothesis is established that “a distribution of products in a certain state (abnormal products) in regard to each item of the manufacturing condition is identical to a distribution of random extraction from a population set”. Next, the null hypothesis is tested, and the p-value thereof is computed. As the p-value becomes smaller, the possibility of rejection of the hypothesis is higher, and the identicalness to the distribution of the random extraction does not apply, i.e., it is suggested that the rate of occurrence of abnormal products in a specific manufacturing condition is high. From this, it is estimated that in the case where the p-value is low, the degree by which the manufacturing condition Cj contributes to the abnormality cause is high. A G-value that is a test quantity of the G-test is computed by the following equation.

$$G = 2 {\sum }_{d = 1}^{K} {O}_{d} \cdot {log}_{e} ( {O}_{d} / {E}_{d} ) \qquad ( 1 )$$

Ed is the number of products expected in the null hypothesis, and is computed by the following equation.

$${E}_{d} = P ( d ) \sim \frac{N}{K} \qquad ( 2 )$$

P(d) is an expected probability, and is a probability of occurrence of products determined to be abnormal in the item d, in the case where the null hypothesis is established. If the true value of the expected probability is unknown, approximation is made by N/K, where N is the total number of products and K is the number of kinds of items. Next, using a chi-square distribution f(x, k), the p-value corresponding to the G-value is computed by the following equation.

p=∫_{G}^{∞}f(x,k)dx (3)

where k is a degree of freedom of the chi-square distribution, and k=K−1. In the chi-square distribution, as the degree of freedom k is higher, the p-value less easily becomes smaller. In a case where the number K of kinds of items of the manufacturing conditions is large, a bias tends to easily occur even in random extraction, and the signification of the bias is evaluated by considering the number K of items, based on the above-described characteristic. According to the above modification, the computation unit 240 computes the p-value for each manufacturing condition Cj, and can compute the first index value F(D) that is the vector including the computed p-value as the element. By the same method, the second index value F(Di) can be computed in regard to the second condition. Subsequently, in the same manner as described above, by computing the similarity between the first index value F(D) and the second index value F(Di), the second condition i with a similar bias of the manufacturing condition can be searched.

Furthermore, in the first embodiment, although the bias rate in regard to each manufacturing condition is used as the index value, the first embodiment is not limited to this. For example, the computation unit 240 may use a quantifying method by using a model to which the factor data D is input and which outputs the first index value F(D). The model may be designed by machine learning or by a freely designed function. The freely designed function is, for example, a logistic regression model or the like, but is not limited to this. In the case of the model design by machine learning, there are an unsupervised model and a supervised model. In the case of the supervised model, a correct-answer label is given to each analysis range in advance, and the model is trained such that output data become close to each other in regard to input data to which the same correct-answer label is given. In addition, the supervised model can be implemented by training the model such that output data do not become close to each other in regard to input data to which different correct-answer labels are given. On the other hand, in the case of the unsupervised model, the model can be implemented by being designed such that similar factor data D are classified into the same class, by using a clustering model such as K-Means. In any case, the computation model 240 computes the first index value and the second index value by using a trained model that is trained to output index values, based on factor data that is input. Thus, according to this modification, the setting method of setting the first index value F(D) from the factor data D can be determined in a data-driven manner.

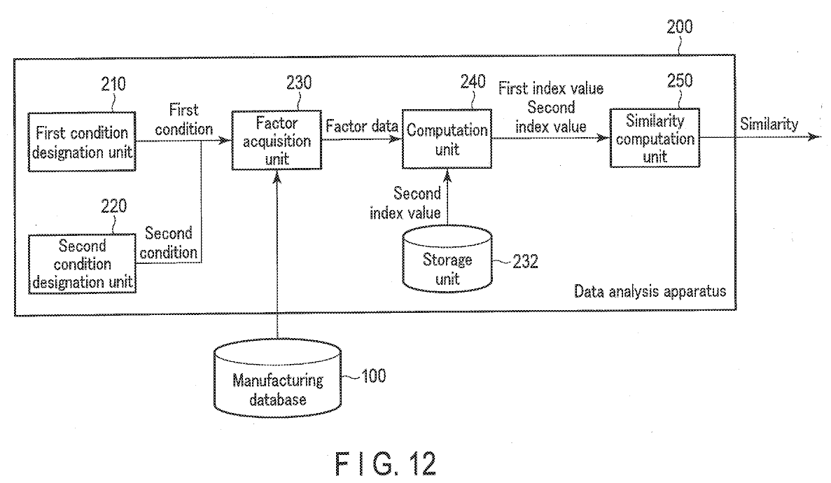

Besides, in the first embodiment, the second index value F(Di) is computed based on the second factor data Di, but the first embodiment is not limited to this. For example, as illustrated in FIG. 12, the data analysis apparatus 200 may include a storage unit 232 in which the second condition and the second index value are correlated and stored. Specifically, the storage unit 232 correlates and stores conditions, such as the first condition and the second condition, and index values, such as the first index value and the second index value. However, since the first condition and the first index value are stored after the computation of the first index value F(D), the storage unit 232 does not store, at a time point when a new first condition is designated, the new first condition and a first index value F(D) corresponding to the new first condition. In addition, the computation unit 240 searches the storage unit 232, based on the designated second condition, and can acquire the second index value F(Di) from the storage unit 232. Specifically, according to this modification, in addition to the advantageous effects of the first embodiment, after a second index value F(Di) corresponding to a second condition is first computed, if the same second condition is designated, the second index value F(Di) can be acquired from the storage unit 232 without computing the second index value F(Di).

Next, in the first embodiment, since a concrete example of the computation of the similarity was not described, the concrete example is described below. For example, if F(D)=(p1, . . . , pJ), and F(Di)=(pi, 1, . . . , pi, J), the similarity computation unit 250 computes, as a similarity, a correlation coefficient Si between the first index value F(D) of the first condition and the second index value F(Di) of the second condition i, as indicated by the following equation.

$${S}_{i} = \frac{{\sum }_{j = 0}^{J} ( {p}_{j} - \overline{p} ) ( {p}_{i , j} - \overline{{p}_{i}} )}{\sqrt{{\sum }_{j = 0}^{J} {( {p}_{j} - \overline{p} )}^{2}} \sqrt{{\sum }_{j = 0}^{J} {( {p}_{i , j} - \overline{{p}_{i}} )}^{2}}} \qquad ( 4 )$$

Here, a sign “⁻” added to p is a bar sign indicative of an average value. Hereinafter, p with the bar sign is expressed by p⁻. Symbol p⁻ indicates an average value of F(D). Similarly, pi with the bar sign is expressed by pi⁻. Symbol pi⁻ indicates an average value of F(Di). By the following equations, p⁻ and pi⁻ are computed.

$$\overline{p} = \frac{{\sum }_{j = 0}^{J} {p}_{j}}{J} \qquad ( 5 )$$

$$\overline{{p}_{i}} = \frac{{\sum }_{j = 0}^{J} {p}_{i , j}}{J} \qquad ( 6 )$$

The correlation coefficient is an index for measuring the strength/weakness of a linear relation between two data, and takes a value in a range of [−1, 1] in accordance with the strength/weakness of the relation. In a case where a correlation is present, the value of the correlation coefficient becomes closer to 1, and in a case where an inverse correlation is present, the value of the correlation coefficient becomes closer to −1. If a correlation is absent, the value of the correlation coefficient becomes closer to 0. Thus, if the correlation coefficient is used as the similarity, the relation between two data can be expressed as a numerical value, and the second index value F(Di) with a high correlation can be extracted. In addition, based on the second factor data Di used in the computation of the extracted second index value F(Di), the second condition i with a similar bias of the manufacturing condition can be searched from the manufacturing database 100 or the storage unit 232.

Besides, in the first embodiment, the first condition is designated (ST10), the second condition is designated (ST20), the factor data D and Di and the index values F(D) and F(Di) are acquired (ST30 and ST40), and the similarity Si is acquired (ST50). However, the order of steps is not limited to this. For example, as is understood from FIG. 5, the order of steps may be such that, after the first condition is designated and the first factor data D and first index value F(D) are acquired, the second condition i is designated, the second factor data Di and second index value F(Di) are acquired, and the similarity Si is acquired. Note that either the process from the designation of the first condition to the acquisition of the first index value F(D), or the process from the designation of the second condition i to the acquisition of the second index value F(Di), may be executed earlier. In this modification, too, the advantageous effects of the first embodiment can be obtained.

### Second Embodiment

Next, a second embodiment is described. Compared to the first embodiment, a data analysis apparatus according to the second embodiment narrows down the first products of the analysis target and the second products of the comparison target to abnormal-state products. Thereby, the data analysis apparatus further improves the accuracy in the case of estimating the abnormality cause.

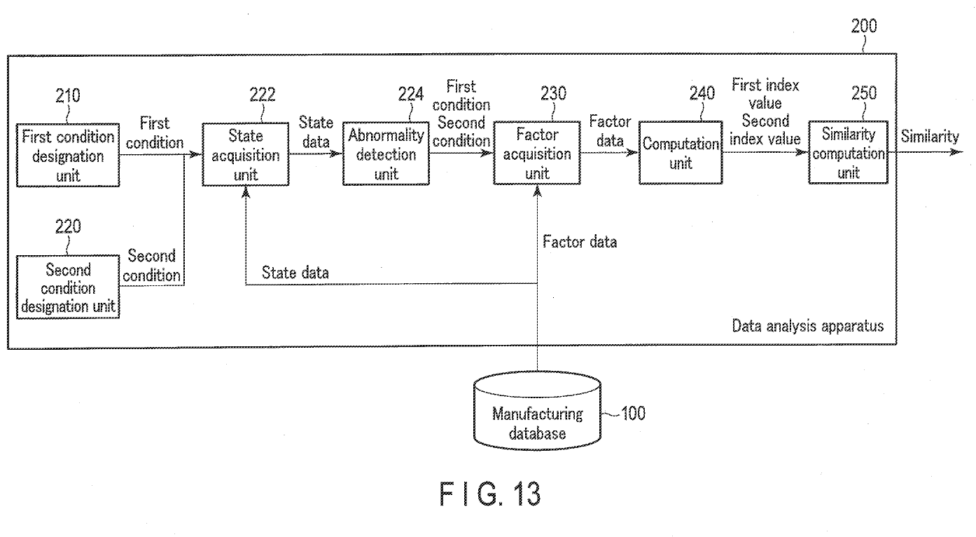

FIG. 13 is a block diagram illustrating a configuration of the data analysis apparatus according to the second embodiment. Structural elements similar to the above-described structural elements are denoted by identical reference signs, and a detailed description thereof is omitted, and different parts are mainly described here. In the embodiments to be described below, overlapping descriptions are similarly omitted.

In FIG. 13, compared to the configuration illustrated in FIG. 1, the data analysis apparatus 200 further includes a state acquisition unit 222 and an abnormality detection unit 224.

Here, the state acquisition unit 222 acquires first state data indicative of the state of the first product, based on the first condition designated by the first condition designation unit 210. Similarly, the state acquisition unit 222 acquires second state data indicative of the state of the second product, based on the second condition designated by the second condition designation unit 220. Note that as the state data according to the second embodiment, for example, use can be made of, as appropriate, data that is used for quality control of products (the dimensions of products, and electrical characteristics such as voltage and resistance).

The abnormality detection unit 224 detects the abnormal state of the first product, based on the first state data, and corrects (re-designates) the first condition in such a manner as to indicate the first product in the detected abnormal state. Similarly, the abnormality detection unit 224 detects the abnormal state of the second product, based on the second state data, and corrects (re-designates) the second condition in such a manner as to indicate the second product in the detected abnormal state. For example, the abnormality detection unit 224 may detect the abnormal state of the first product by a statistical process based on the first state data, and may detect the abnormal state of the second product by a statistical process based on the second state data.

In accordance with this, the factor acquisition unit 230 acquires the first factor data, based on the corrected first condition, and acquires the second factor data, based on the corrected second condition.

The other configuration is the same as in the first embodiment.

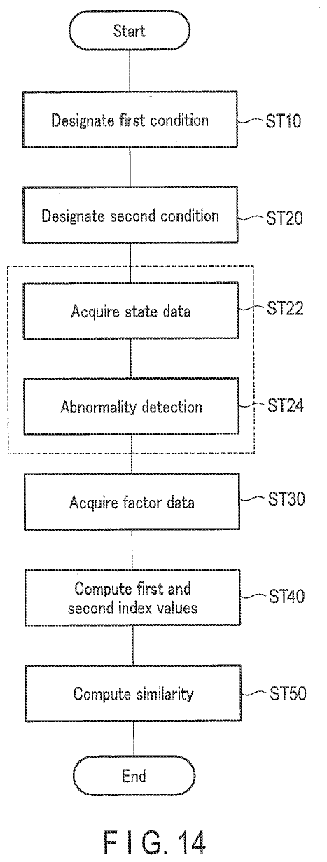

Next, an operation of the data analysis apparatus with the above configuration is described with reference to a flowchart of FIG. 14.

In the same manner as described above, by the execution of steps ST10 and ST20, the first condition and the second condition are designated.

(Step ST22)

The state acquisition unit 222 acquires, based on the designated first condition, the first state data indicative of the state of the first product from the state data 100S in the manufacturing database 100. Similarly, the state acquisition unit 222 acquires, based on the designated second condition, the second state data indicative of the state of the second product from the state data 100S in the manufacturing database 100.

(Step ST24)

The abnormality detection unit 224 detects the abnormal state of the first product, based on the first state data, and corrects (re-designates) the first condition in such a manner as to indicate the first product in the detected abnormal state. Similarly, the abnormality detection unit 224 detects the abnormal state of the second product, based on the second state data, and corrects (re-designates) the second condition in such a manner as to indicate the second product in the detected abnormal state.

For example, in a case where the state data is an outlier or a value deviating a standard value, the abnormality detection unit 224 detects that the product corresponding to the state data is in an abnormal state. Hereinafter, by way of example, a method of outlier detection by 3-sigma that is a general statistical process is described, the outlier detection by the abnormality detection unit 224 is not limited to this. The abnormality detection unit 224 may use, for example, a method of detecting an outlier by a rule base or machine learning.

The outlier detection method by 3-sigma uses the presupposition of the statistical process that 99.7% of the state data is included within 3 standard deviations of an average in a case where the state data follows a normal distribution. Note that the state data of 0.3%, which is not included in the 3 standard deviations of the average is an outlier and is abnormal.

Accordingly, for example, the abnormality detection unit 224 acquires the state data from the manufacturing database 100 by using as a key the manufacturing number indicated in the designated first condition. In addition, if the average of the acquired state data is μ and the standard deviation is σ, the abnormality detection unit 224 detects that the first product of the manufacturing number, which has state data outside the range of μ±3σ, is in the abnormal state.

Thereafter, the abnormality detection unit 224 corrects the designated first condition in such a manner as to narrow down the designated first condition to a first condition in an abnormal state. Similarly, the abnormality detection unit 224 corrects the designated second condition in such a manner as to narrow down the designated second condition to a second condition in an abnormal state.

(Step ST30)

The factor acquisition unit 230 acquires the first factor data, based on the corrected first condition, and acquires the second factor data, based on the corrected second condition.

Subsequently, in the same manner as described above, the process of step ST40 onwards is executed.

As described above, according to the second embodiment, the state acquisition unit 222 acquires the first state data indicative of the state of the first product, based on the first condition designated by the first condition designation unit 210. Similarly, the state acquisition unit 222 acquires the second state data indicative of the state of the second product, based on the second condition designated by the second condition designation unit 220. The abnormality detection unit 224 detects the abnormal state of the first product, based on the first state data, and corrects the first condition in such a manner as to indicate the first product in the detected abnormal state. Similarly, the abnormality detection unit 224 detects the abnormal state of the second product, based on the second state data, and corrects the second condition in such a manner as to indicate the second product in the detected abnormal state. The factor acquisition unit 230 acquires the first factor data, based on the corrected first condition, and acquires the second factor data, based on the corrected second condition. Accordingly, in addition to the advantageous effects of the first embodiment, by narrowing down the first products of the analysis target and the second products of the comparison target to abnormal-state products, the accuracy in the case of estimating the abnormality cause can further be improved. Moreover, after detecting an abnormal state such as an outlier in regard to the state data of products, a similar case to an abnormal-state product can be searched.

Additionally, according to the second embodiment, the abnormality detection unit 224 may detect the abnormal state of the first product by a statistical process based on the first state data, and may detect the abnormal state of the second product by a statistical process based on the second state data. In this case, in addition to the above-described advantageous effects, at a time of narrowing down the products of the analysis target and the comparison target to abnormal-state products, no labor is needed to prepare a rule base, a trained model or the like in advance, and the abnormal state can be detected by the statistical process.

### Modifications of the Second Embodiment

Next, modifications of the second embodiment are described. Each modification is similarly applicable to embodiments to be described below.

In the second embodiment, the abnormal state of products is detected by the statistical process of the state data, but the second embodiment is not limited to this. For example, the abnormality detection unit 224 may detect, based on the first state data, the abnormal state of the first product by a machine learning model that is trained in advance, and may detect, based on the second state data, the abnormal state of the second product by the machine learning model. In this case, in addition to the advantageous effects of the second embodiment, even in a situation with a small number of state data, which is not suitable for the statistical process, the abnormal state can be detected by the machine learning model.

In addition, in the second embodiment, the data used for quality control of products (the dimensions of products, and electrical characteristics such as voltage and resistance) are used as the state data, but the second embodiment is not limited to this. Flag information that is an inspection result of products may be used as the state data. In this case, the first condition or the second condition may be designated based on the flag information. For example, if flag information “1” represents an abnormal state and flag information “0” represents a normal state, the designated first condition may be corrected and changed to the first condition indicative of the manufacturing number of the flag information “1”. Similarly, the designated second condition may be corrected and changed to the second condition indicative of the manufacturing number of the flag information “1”. According to the present modification, the advantageous effects of the second embodiment can be obtained without using a statistical process, a machine learning model, a rule base, or the like.

### Third Embodiment

Next, a third embodiment is described. Compared to the first embodiment, a data analysis apparatus according to the third embodiment outputs a similarity and a second condition, which are a data analysis result. Thereby, the data analysis apparatus presents the similarity and the second condition to the user via an apparatus that is an output destination.

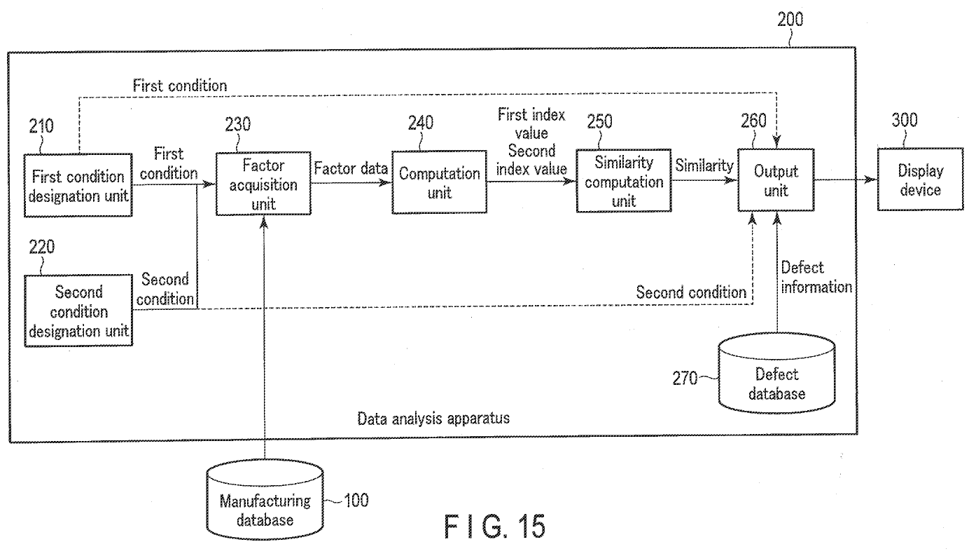

FIG. 15 is a block diagram illustrating a configuration of the data analysis apparatus according to the third embodiment. Compared to the configuration illustrated in FIG. 1, the data analysis apparatus 200 further includes an output unit 260 and a defect database 270. The output unit 260 is connected to a display device 300.

Here, the output unit 260 acquires the computed similarity Si, and outputs the similarity Si and the second condition i to the display device 300. Note that the output unit 260 may receive the information relating to the first condition from the first condition designation unit 210, and the information relating to the second condition from the second condition designation unit 220. In addition, the output unit 260 may output the first condition, the second condition i and the similarity Si to the display device 300. Besides, the output unit 260 may acquire the information relating to the second condition i from the defect database 270, and may output the acquired information, the similarity Si and the second condition i to the display device 300.

The defect database 270 is a storage device that stores information relating to defective products. The information relating to defective products includes the following pieces of information (Ia) to (Ic), but is not limited to these.

(Ia) Manufacturing numbers, manufacturing dates, manufacturing lots, and other manufacturing conditions of defective products.

(Ib) Information relating to defective products (a defect occurrence condition, a defect occurrence cause, and measures to deal with defective products).

(Ic) Link information to defect reports (word, pdf).

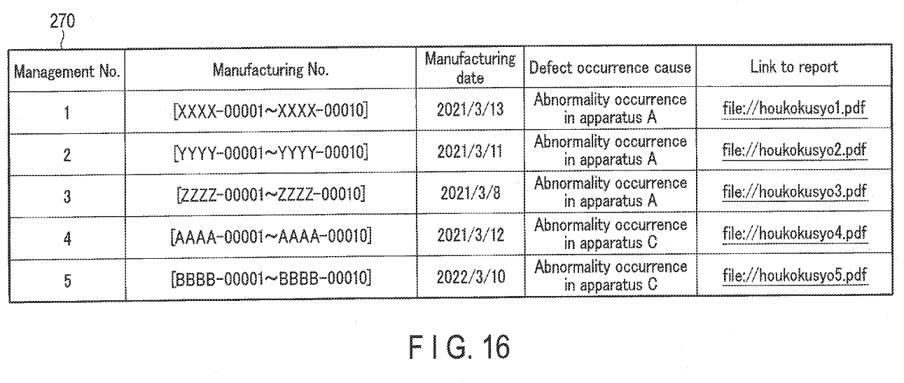

For example, as illustrated in FIG. 16, the defect database 270 stores, in respective columns, a management number of a defective product, a manufacturing number, a manufacturing date, a defect occurrence cause, and a link to a report. In addition, in each row of the defect database 270, information relating to defective products is recorded in regard to each product group. Note that each of the manufacturing number and the manufacturing date corresponds to the second condition indicative of second products of the comparison target. Accordingly, the output unit 260 can acquire, with use of the second condition i as a query, the information relating to defective products agreeing with the query.

The display device 300 is a display that displays the similarity Si and second condition i, which are output from the output unit 260. Specifically, the display device 300 presents to the user or the like the second condition i corresponding to a manufacturing condition, which is similar to a manufacturing condition corresponding to the first condition.

The other configuration is the same as in the first embodiment.

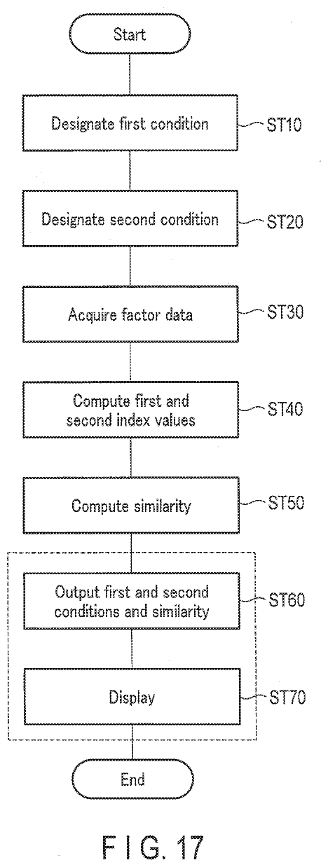

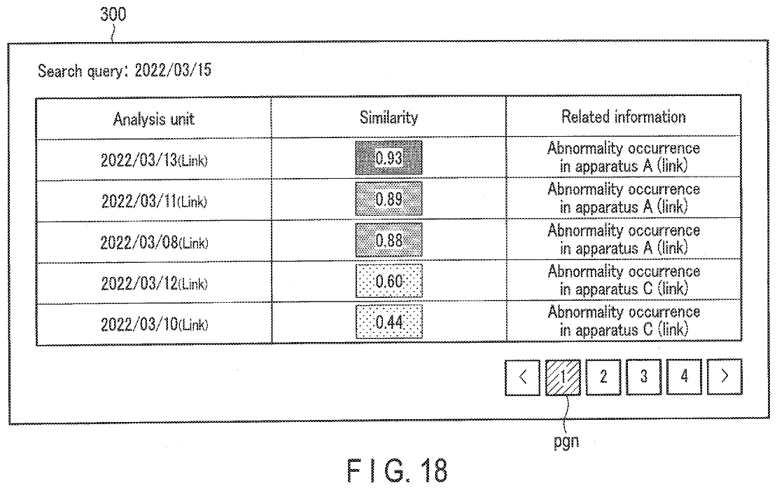

Next, an operation of the data analysis apparatus with the above configuration is described with reference to a flowchart of FIG. 17 and a schematic view of FIG. 18.

In the same manner as described above, if the first condition and the second condition i are designated by the execution of steps ST10 to ST50, the similarity Si is computed after the respective processes.

(Step ST60)

The output unit 260 receives the information relating to the first condition from the first condition designation unit 210, and the information relating to the second condition from the second condition designation unit 220. The output unit 260 searches the defect database 270, based on the second condition i, and acquires the information relating to defective products in regard to the second condition i. Thereafter, the output unit 260 outputs the first condition, the second condition i, the similarity Si and the information relating to defective products to the display device 300. It should be noted, however, that the first condition and the information relating to defective products may not be output.

(Step ST70)

The display device 300 displays an analysis result, based on the output of the output unit 260. For example, as illustrated in FIG. 18, the display device 300 displays an analysis unit, a similarity Si and related information by correlating the analysis unit, similarity Si and related information. In the example illustrated in FIG. 18, the date of the analysis unit is a second condition indicative of the second product of the comparison target, and is a manufacturing date in a case of indicating the second product by the second condition that designates the manufacturing date (factor data). Note that the manufacturing date of the second product corresponds to the manufacturing date of a defective product in the defect database 270, as well as the manufacturing date included in the factor data. Link information in the vicinity of the date of the analysis unit is linked to the factor data 100D, and, if selected, causes a screen transition to the factor data 100D. The related information is information relating to a defective product correlated with the second condition i, and corresponds to the defect occurrence cause in the defect database 270. Link information in the vicinity of the related information is linked to the defect database 270, and, if selected, causes a screen transition to the defect database 270. In addition, the display device 300 displays the date of a search query, and pagination pgn. In the example illustrated in FIG. 18, the date of the search query is the first condition indicative of the first product of the analysis target, and is a manufacturing date in a case of indicating the first product by the first condition that designates the manufacturing date (factor data). The pagination pgn includes a plurality of page buttons for dividedly displaying, on a page-by-page basis, an area in which the analysis unit, the similarity and the related information are correlated.

This display mode of the display device 300 may be changed in accordance with the similarity Si of the product designated by the second condition i. For example, in accordance with the similarity Si, the display device 300 may arrange and display the respective data elements, such as the analysis unit, similarity and related information, in the order of similarity. Alternatively, the display device 300 may display the respective data elements by sorting the data elements in a descending order or an ascending order of the similarity Si of each data element. In addition, the display device 300 may display, with emphasis, data elements having close similarities Si. As the display with emphasis, for example, use can be made of enlargement in character size, bold-face display, color display, or the like as appropriate. Alternatively, the display device 300 may effect display by changing the display color in accordance with the magnitude of the similarity Si. The display with changed display colors may be effected, for example, with such gradations that a color closer to red is used for a greater similarity Si, and a color closer to blue is used for a lower similarity. In FIG. 18, the display with half-tone dot meshing represents the gradations. In addition, for example, the display device 300 may not display data elements with similarity Si of a threshold or less. In this case, for example, by a user operation or the like, the display/non-display of the data elements with similarity Si of a threshold or less may be changed. For example, the data elements with similarity Si of a threshold or less may be displayed after a screen transition to the next page by an operation of the pagination pgn. Besides, in a case where the display device 300 receives the defect information in the defect database 270 from the output unit 260, the display device 300 may arrange and display each data element and defect information in a juxtaposed manner. In any case, the display device 300 displays the analysis result by the data analysis apparatus 200. The user specifies the abnormality cause by visually recognizing the displayed analysis result.

As described above, according to the third embodiment, the output unit 260 acquires the computed similarity Si, and outputs the similarity Si and the second condition i. Thereby, in addition to the above-described advantageous effects, the similarity Si and the second condition i can be presented to the user.

Furthermore, according to the third embodiment, the output unit 260 may acquire the information relating to the second condition i, and may output the acquired information, the similarity Si and the second condition i. In this case, in addition to the above-described advantageous effects, the information relating to the second condition i can be presented to the user.

### Modifications of the Third Embodiment

Next, modifications of the third embodiment are described. Each modification is similarly applicable to embodiments to be described below.

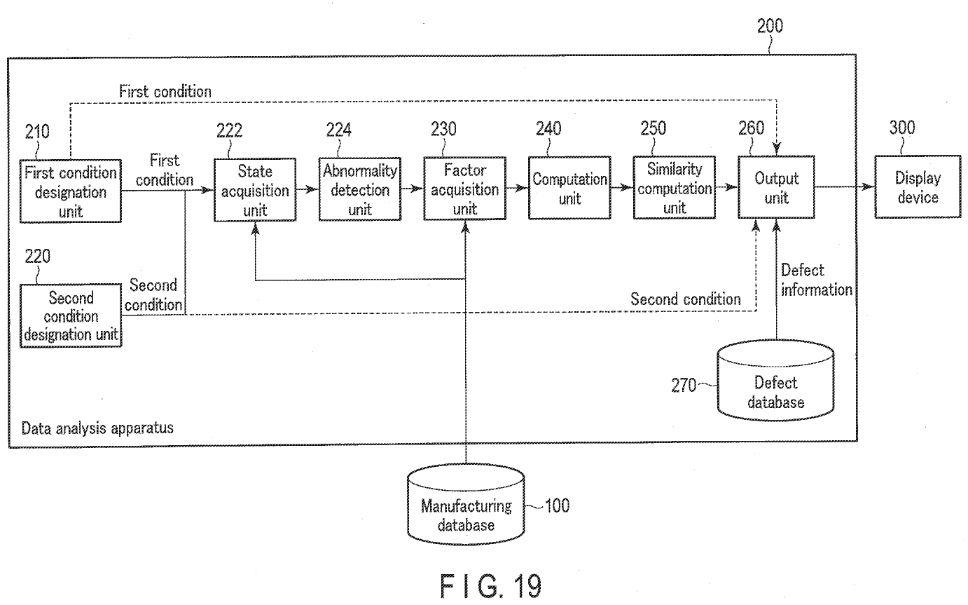

Although the third embodiment was described as a modification of the first embodiment, the third embodiment is not limited to this. For example, as illustrated in FIG. 19, the data analysis apparatus 200 may be a modification of the second embodiment. Compared to the configuration illustrated in FIG. 15, the data analysis apparatus 200 further includes an output unit 260 and a defect database 270. The output unit 260 is connected to a display device 300. Here, the configurations of the output unit 260, defect database 270 and display device 300 are the same as in the third embodiment. The other configuration is the same as in the second embodiment. Therefore, according to this modification, the operations and advantageous effects of the second and third embodiments can be obtained.

### Fourth Embodiment

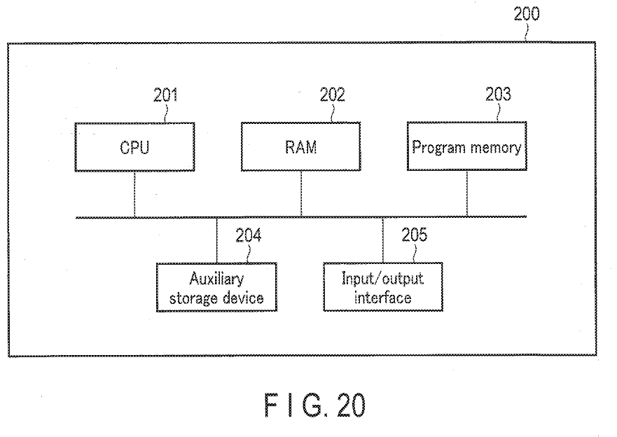

FIG. 20 is a block diagram illustrating an example of a hardware configuration of a data analysis apparatus according to a fourth embodiment. The fourth embodiment is a concrete example of the first to third embodiments, in which the data analysis apparatus 200 is implemented by a computer.

The data analysis apparatus 200 includes, as hardware, a CPU (Central Processing Unit) 201, a RAM (Random Access Memory) 202, a program memory 203, an auxiliary storage device 204, and an input/output interface 205. The CPU 201 communicates with the RAM 202, program memory 203, auxiliary storage device 204 and input/output interface 205 via a bus. Specifically, the data analysis apparatus 200 of the present embodiment is implemented by a computer with this hardware configuration.

The CPU 201 is an example of a general-purpose processor. The RAM 202 is used by the CPU 201 as a working memory. The RAM 202 includes a volatile memory such as an SDRAM (Synchronous Dynamic Random Access Memory). The program memory 203 stores a data analysis program for implementing the respective components according to each embodiment. This data analysis program may be, for example, a program for enabling the computer to implement the functions of the first condition designation unit 210, second condition designation unit 220, state acquisition unit 222, abnormality detection unit 224, factor acquisition unit 230, computation unit 240, similarity computation unit 250 and output unit 260. In addition, as the program memory 203, for example, a ROM (Read-Only Memory), a part of the auxiliary storage device 204, or a combination thereof is used. The auxiliary storage device 204 non-transitorily stores data. The auxiliary storage device 204 includes a nonvolatile memory such as an HDD (hard disk drive) or an SSD (solid state drive).

The input/output interface 205 is an interface for connection to other devices. The input/output interface 205 is used, for example, for connection to a keyboard, a mouse, a database and a display.

The data analysis program stored in the program memory 203 includes computer executable instructions. If the data analysis program (computer executable instructions) is executed by the CPU 201 that is processing circuitry, the data analysis program causes the CPU 201 to execute a predetermined process. For example, if the data analysis program is executed by the CPU 201, the data analysis program causes the CPU 201 to execute sequential processes described in connection with the respective components in FIG. 1, FIG. 5, FIG. 12, FIG. 13, FIG. 15 or FIG. 19. For example, if the computer executable instructions included in the data analysis program are executed by the CPU 201, the computer executable instructions cause the CPU 201 to execute the data analysis method. The data analysis method may include the steps corresponding to the functions of the above-described first condition designation unit 210, second condition designation unit 220, state acquisition unit 222, abnormality detection unit 224, factor acquisition unit 230, computation unit 240, similarity computation unit 250 and output unit 260. Besides, the data analysis method may include, as appropriate, the steps illustrated in FIG. 4, FIG. 14 or FIG. 17.

The data analysis program may be provided to the data analysis apparatus 200 that is a computer, in a state in which the data analysis program is stored in a computer readable storage medium. In this case, for example, the data analysis apparatus 200 further includes a drive (not illustrated) that reads data from the storage medium, and acquires the data analysis program from the storage medium. As the storage medium, for example, use can be made of, as appropriate, a magnetic disk, an optical disc (CD-ROM, CD-R, DVD-ROM, DVD-R, or the like), a magneto-optical disc (MO or the like), or a semiconductor memory. The storage medium may be called “non-transitory computer readable storage medium”. In addition, the data analysis program may be stored in a server on a communication network, and the data analysis apparatus 200 may download the data analysis program from the server by using the input/output interface 205.

The processing circuitry that executes the data analysis program is not limited to a general-purpose hardware processor such as the CPU 201, and a purpose-specific hardware processor such as an ASIC (Application Specific Integrated Circuit) may be used. The term “processing circuitry (processing unit)” includes at least one general-purpose hardware processor, at least one purpose-specific hardware processor, or a combination of at least one general-purpose hardware processor and at least one purpose-specific hardware processor. In the example illustrated in FIG. 20, the CPU 201, RAM 202 and program memory 203 correspond to the processing circuitry.

According to at least one of the above-described embodiments, the accuracy in the case of estimating an abnormality cause in a manufacturing process can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data analysis apparatus comprising processing circuitry configured to:
designate a first condition indicative of a first product of an analysis target;
designate a second condition indicative of a second product of a comparison target;
acquire, based on the first condition, first factor data indicative of a plurality of first manufacturing conditions of the first product, and acquire, based on the second condition, second factor data indicative of a plurality of second manufacturing conditions of the second product;
compute, based on the first factor data, a first index value relating to a degree by which each of the first manufacturing conditions contributes to an abnormality cause of the first product, and compute, based on the second factor data, a second index value relating to a degree by which each of the second manufacturing conditions contributes to an abnormality cause of the second product; and
compute a similarity between the first index value and the second index value.

2. The data analysis apparatus of claim 1, wherein the processing circuitry is configured to:
designate one or more second conditions different from the first condition;
acquire the second factor data in regard to each of the second conditions;
compute the second index value in regard to each of the second factor data; and
compute the similarity in regard to each of the second index values.

3. The data analysis apparatus of claim 1, wherein the processing circuitry is configured to compute the first index value, based on the first factor data and a statistical hypothesis test, and to compute the second index value, based on the second factor data and the statistical hypothesis test.

4. The data analysis apparatus of claim 1, wherein the processing circuitry is configured to compute the first index value and the second index value by using a trained model that is trained to output index values, based on factor data that is input.

5. The data analysis apparatus of claim 1, wherein
the processing circuitry is further configured to:
acquire first state data indicative of a state of the first product, based on the first condition, and acquire second state data indicative of a state of the second product, based on the second condition; and
detect an abnormal state of the first product, based on the first state data, correct the first condition in such a manner as to indicate the first product in the detected abnormal state, detect an abnormal state of the second product, based on the second state data, and correct the second condition in such a manner as to indicate the second product in the detected abnormal state, and
the processing circuitry is configured to acquire the first factor data, based on the corrected first condition, and to acquire the second factor data, based on the corrected second condition.

6. The data analysis apparatus of claim 5, wherein the processing circuitry is configured to detect the abnormal state of the first product by a statistical process based on the first state data, and to detect the abnormal state of the second product by a statistical process based on the second state data.

7. The data analysis apparatus of claim 5, wherein the processing circuitry is configured to detect, based on the first state data, the abnormal state of the first product by a machine learning model that is trained in advance, and to detect, based on the second state data, the abnormal state of the second product by the machine learning model.

8. The data analysis apparatus of claim 1, further comprising a memory in which the second condition and the second index value are correlated and stored, wherein
the processing circuitry is configured to acquire the second index value from the memory, based on the second condition.

9. The data analysis apparatus of claim 1, wherein the processing circuitry is configured to acquire the computed similarity and to output the similarity and the second condition.

10. The data analysis apparatus of claim 9, wherein the processing circuitry is configured to acquire information relating to the second condition, and to output the acquired information, the similarity and the second condition.

11. The data analysis apparatus of claim 3, wherein the statistical hypothesis test is a G-test.

12. The data analysis apparatus of claim 3, wherein the statistical hypothesis test is a chi-square test.

13. A data analysis method comprising:
designating a first condition indicative of a first product of an analysis target;
designating a second condition indicative of a second product of a comparison target;
acquiring, based on the first condition, first factor data indicative of a plurality of first manufacturing conditions of the first product;
acquiring, based on the second condition, second factor data indicative of a plurality of second manufacturing conditions of the second product;
computing, based on the first factor data, a first index value relating to a degree by which each of the first manufacturing conditions contributes to an abnormality cause of the first product;
computing, based on the second factor data, a second index value relating to a degree by which each of the second manufacturing conditions contributes to an abnormality cause of the second product; and
computing a similarity between the first index value and the second index value.

14. A non-transitory computer readable storage medium including computer executable instructions, wherein the instructions, when executed by a processor, cause the processor to perform a method comprising:
designating a first condition indicative of a first product of an analysis target;
designating a second condition indicative of a second product of a comparison target;
acquiring, based on the first condition, first factor data indicative of a plurality of first manufacturing conditions of the first product;
acquiring, based on the second condition, second factor data indicative of a plurality of second manufacturing conditions of the second product;
computing, based on the first factor data, a first index value relating to a degree by which each of the first manufacturing conditions contributes to an abnormality cause of the first product;
computing, based on the second factor data, a second index value relating to a degree by which each of the second manufacturing conditions contributes to an abnormality cause of the second product; and
computing a similarity between the first index value and the second index value.
